(19) United States
(12) Patent Application Publication
(10) Pub. No.: US 2014/0078961 A1
(43) Pub. Date: Mar. 20, 2014

(54) METHOD AND SYSTEM FOR DETECTING SYNCHRONIZATION SIGNALS IN A MOBILE COMMUNICATIONS PROTOCOL

(71) Applicant: Marvell World Trade Ltd., St. Michael (BB)

(72) Inventors: Manyuan Shen, Milpitas, CA (US); Chusong Xiao, Union City, CA (US); Qing Zhao, Milpitas, CA (US); Leilei Song, Sunnyvale, CA (US); Hui-Ling Lou, Sunnyvale, CA (US)

(73) Assignee: Marvell World Trade Ltd., St. Michael (BB)

(21) Appl. No.: 14/020,365

(22) Filed: Sep. 6, 2013

Related U.S. Application Data
(60) Provisional application No. 61/702,444, filed on Sep. 18, 2012.

(51) Int. Cl. H04W 56/00

(52) U.S. Cl. CPC H04W 56/0035
USPC 370/328

(57) ABSTRACT

A method of detecting a secondary synchronization signal in a received signal having desired primary and secondary synchronization signals, and interfering primary and secondary synchronization signals, includes providing information regarding primary synchronization signal location and, based on the information regarding primary synchronization signal location, performing successive interference cancellation to remove the interfering secondary synchronization signals for detecting the desired secondary synchronization signal, without performing successive interference cancellation on the primary synchronization signals. Apparatus for detecting a secondary synchronization signal in a received signal having (i) desired primary and secondary synchronization signals and (ii) interfering primary and secondary synchronization signals includes a source of information regarding primary synchronization signal location, and successive interference cancellation circuitry. The successive interference cancellation circuitry uses the information regarding primary synchronization signal location to remove interfering secondary synchronization signals for detecting the desired secondary synchronization signal, without performing successive interference cancellation on the primary synchronization signals.

### CROSS REFERENCE TO RELATED APPLICATION

This claims the benefit of, and priority to, copending, commonly-assigned U.S. Provisional Patent Application No. 61/702,444, filed Sep. 18, 2012, which is hereby incorporated by reference herein in its entirety.

### FIELD OF USE

This disclosure relates to a method and system for detecting synchronization signals in a mobile communications protocol, such as the Long-Term Evolution (“LTE”) protocol.

### BACKGROUND

Mobile communications protocols such as the 4G-LTE protocol currently in use have a frame/half-frame/subframe structure. Included in that frame/half-frame/subframe structure are synchronization signals. It is important in decoding a mobile communications transmission to be able to locate the synchronization signals, which carry information regarding frame boundaries, cell identities, carrier frequency, etc.

A number of factors may increase the difficulty of identifying the synchronization signals. For example, it may be more difficult to identify the synchronization signals when a user is moving around than when the user is standing still. Similarly, synchronization signals from other sources may arrive at around the same time at around the same frequency (e.g., from a service of the same carrier as the user's carrier but to which the user does not subscribe).

One technique used to identify the synchronization signals in the presence of such interfering signals is “successive interference cancellation” (SIC), which is an iterative technique in which multiple interfering signals are detected and subtracted sequentially until the clear desired signal remains. However, as currently applied to LTE synchronization signals, SIC is computationally intensive and time-consuming.

### SUMMARY

In accordance with this disclosure, there is provided a method of detecting a secondary synchronization signal in a received signal having desired primary and secondary synchronization signals and interfering primary and secondary synchronization signals. The method includes providing information regarding primary synchronization signal location and, based on the information regarding primary synchronization signal location, performing successive interference cancellation to remove the interfering secondary synchronization signals for detecting the desired secondary synchronization signal, without performing successive interference cancellation on the primary synchronization signals.

There is also provided apparatus for detecting a secondary synchronization signal in a received signal having (i) desired primary and secondary synchronization signals and (ii) interfering primary and secondary synchronization signals. The apparatus includes a source of information regarding primary synchronization signal location, and successive interference cancellation circuitry. The successive interference cancellation circuitry uses the information regarding primary synchronization signal location to remove the interfering secondary synchronization signals for detecting the desired secondary synchronization signal, without performing successive interference cancellation on the primary synchronization signals.

A communications system according to this disclosure includes a plurality of base stations, each respective one of the base stations transmitting primary and secondary synchronization signals. The system also includes a plurality of transceivers, each of the transceivers, at any one time, being in communication with a respective one of the base stations and including receiver circuitry for detecting a respective secondary synchronization signal from the respective one of the base stations while receiving (i) desired primary and secondary synchronization signals from the respective one of the base stations and (ii) interfering primary and secondary synchronization signals from other ones of the base stations. The receiver circuitry includes a source of information regarding primary synchronization signal location, and successive interference cancellation circuitry that uses the information regarding primary synchronization signal location to remove the interfering secondary synchronization signals for detecting the desired secondary synchronization signal, without performing successive interference cancellation on the primary synchronization signals.

### BRIEF DESCRIPTION OF THE DRAWINGS

Further features of the disclosure, its nature and various advantages, will be apparent upon consideration of the following detailed description, taken in conjunction with the accompanying drawings, in which like reference characters refer to like parts throughout, and in which:

FIG. 1 shows the structure of a message frame according to the LTE protocol;

FIG. 2 shows a known technique for identifying signals by successive interference cancellation;

FIG. 3 shows a known technique for using successive interference cancellation to identify primary and secondary synchronization signals;

FIG. 4 shows a method and apparatus in accordance with an implementation of the present disclosure for identifying synchronization signals; and

FIG. 5 shows a system in accordance with an implementation of the present disclosure for identifying synchronization signals.

### DETAILED DESCRIPTION

This disclosure describes a method, apparatus and system for more efficiently acquiring LTE synchronization signals using SIC, by applying SIC only to the secondary synchronization signal.

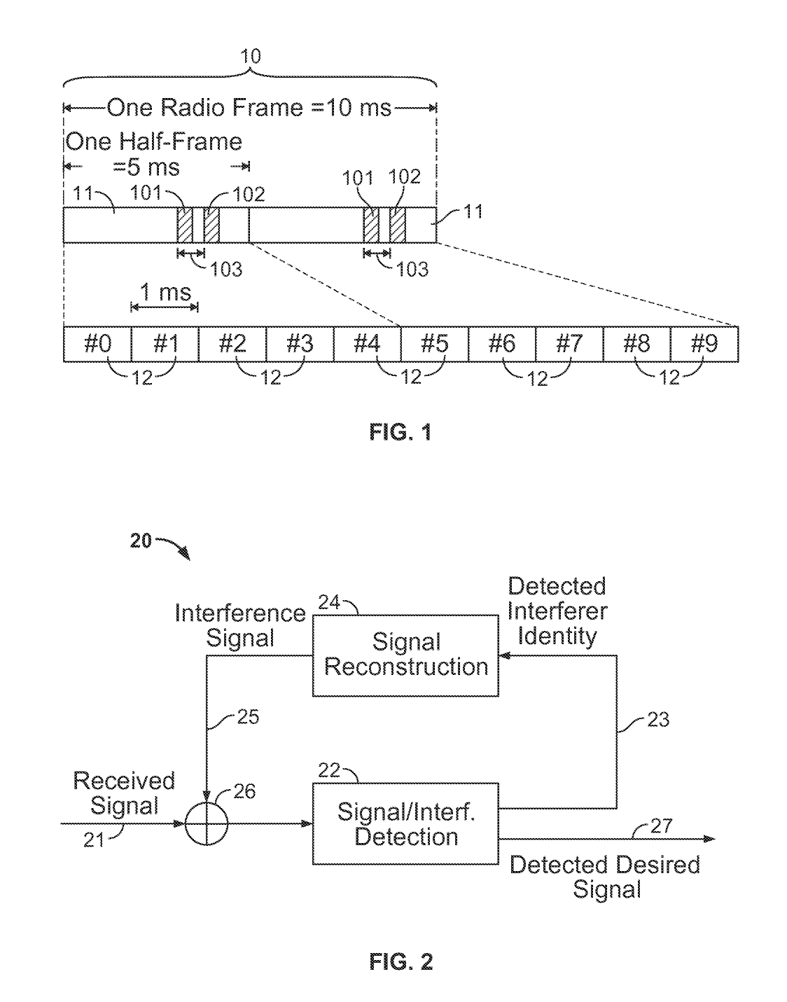

FIG. 1 shows the structure of a message frame according to the LTE protocol. Each full “radio frame” 10 is 10 ms long and is divided into two 5 ms half-frames 11. Each half-frame 11 is further divided into five subframes 12, each of which includes fourteen orthogonal frequency-division multiplexing (OFDM) symbols in the case of normal Cyclic Prefix (CP) length.

Synchronization signals are transmitted in every LTE frame 10, and include both primary synchronization signals (PSSs) 101 and secondary synchronization signals (SSSs) 102. The primary synchronization signal appears in a fixed location in both the time domain and the frequency domain in every half-frame 11. Similarly, the secondary synchronization signal appears in a fixed location in both the time domain and the frequency domain in every half-frame 11. Although shown in FIG. 1 as being offset, the fixed locations of the PSS 101 and SSS 102 can be consecutive or at a fixed offset 103 from one another. In any case, because the PSS 101 and SSS 102 always occur in the same place in each half-frame 11, frame boundary information can be derived from the time location of the synchronization signals, once the synchronization signals are identified.

Cell identity (i.e., the identity of a cell or base station, also known as an “eNB” for “enhanced Node B” or “evolved Node B”) also can be derived from the synchronization signals. Specifically,

Cell identity=3×NID1+NID2

where NID1 is the sequence ID of a secondary synchronization signal, and NID2 is the sequence ID of a primary synchronization signal.

Other information, such as carrier frequency offset, also can be derived from synchronization signal acquisition.

As noted above, the primary synchronization signal is transmitted in a pre-specified location 101 in both the time and frequency domains in every half-frame 11 (i.e., every 5 ms). The primary synchronization signal can have one of three values—i.e., NID2=0, NID2=1, or NID2=2, which provides a lookup to a table of three possible sequence values.

As also noted above, the secondary synchronization signal also is transmitted in a pre-specified location 102 in both the time and frequency domains in every half-frame 11. For each value of NID2 (0, 1 or 2) in the PSS, the SSS can be one of 168 pairs of sequences (NID1=0, 1, 2, . . . 167, which provides a lookup to a table of 168 possible sequence values), with one member of the pair transmitted in the even half-frame and the other member of the pair transmitted in odd half-frames.

To identify itself, a given eNB will transmit the same PSS and the same pair of SSSs in every frame in pre-specified locations 101, 102 in both the frequency domain and the time domain.

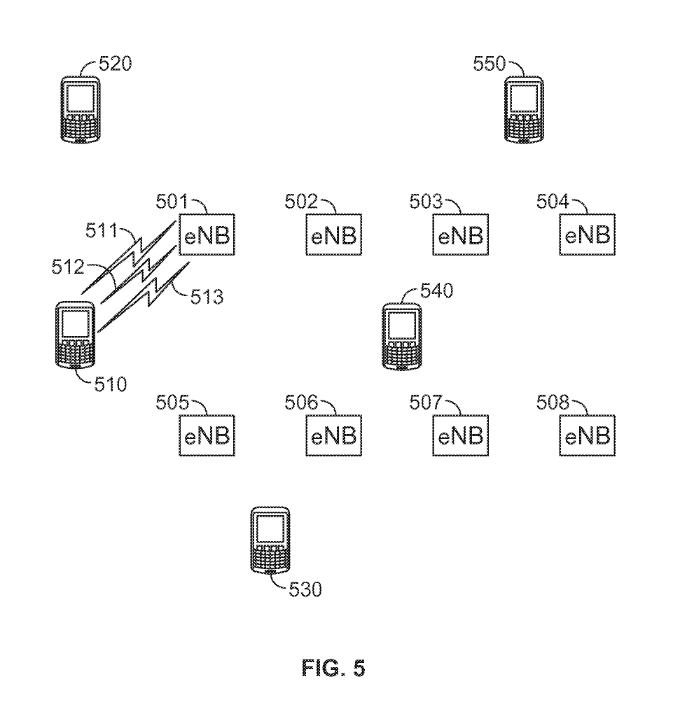

As mentioned above, synchronization signal acquisition is used to identify frame boundaries, cell IDs, carrier frequency, etc. Different synchronization signals from multiple eNBs, sharing the same time and frequency allocations, might be received at one UE (user equipment)—i.e., a mobile handset or other mobile device (see FIG. 5), particularly if the user is in motion. A UE may acquire a synchronization signal during initial network entry or cell re-selection, or for mobility measurement purposes. During initial network entry or cell re-selection, a UE may try to acquire the strongest cell available. For mobility measurement, a UE is required to identify new cells and measure their signal strength on a regular basis. For example, under LTE Release 9, a UE is required to identify and measure up to eight cells on the same frequency (intra-frequency measurement).

Except for the synchronization signals from the desired eNB, other synchronization signals are considered to be interference. In the case of initial network entry and cell re-selection, the desired eNB would be the strongest cell available. In the case of mobility measurement, the desired eNB would be the new cell to be identified. In all of these scenarios, it may be that the received signal strength from desired eNB is weaker than those from other eNBs. Therefore, it may be difficult to acquire the desired eNB because of a low SINR (signal-to-interference-plus-noise ratio).

One known technique for detecting a desired signal, particularly where the interfering signal may have a higher SINR, is successive interference cancellation. The interfering signal or signals, particularly where some or all of them are stronger than the desired signal, can be serially identified and subtracted out in an iterative process 20 such as the one diagrammed in FIG. 2.

Received signal 21 includes one desired signal and one or more interfering signals. At signal/interference detection module 22, an interfering signal is identified. That identity is passed at 23 to signal reconstruction module 24 which isolates and reconstructs the identified interfering signal 25 so that it can be subtracted at 26 from received signal 21. Signal/interference detection module 22 then looks for further interfering signals, sending them to signal reconstruction module 24 and subtractor 25 for further interfering signal removal. Eventually, signal/interference detection module 22 will not find any further interfering signals and will output the desired signal at 27.

This process frequently occurs when a UE is moving and new cells are coming into range, in which case the desired signal would be the synchronization signal of the new cell, while the interfering signals would be the synchronization signals of the current cell and possibly other nearby cells that are already known. In such a case, it is possible that the signals that are already known are stronger than the signal from the new cell, which is just coming into range. Therefore, an acceptable way to identify, in module 22, which signals are the interfering signals, is to identify the strongest signal first, then the next strongest, etc. However, another possibility may be to first identify known signals.

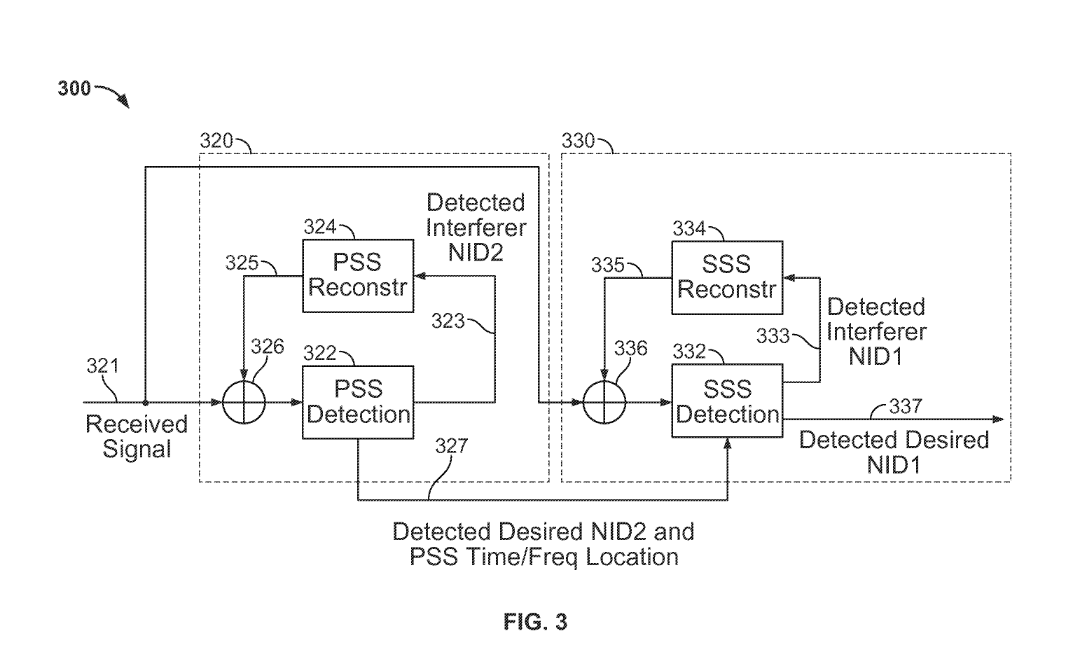

Successive interference cancellation has previously been implemented in LTE synchronization signal detection in the manner shown in FIG. 3. SIC method/circuit 300 includes two SIC loops—a PSS loop 320 and an SSS loop 330.

Received signal 321 is input to PSS loop 320, where signal/interference detection module 322 identifies interfering PSSs. In each pass through loop 320, one interfering PSS identity is passed at 323 to signal reconstruction module 324 which isolates and reconstructs the identified interfering PSS signal 325 so that it can be subtracted at 326 from received signal 321. Signal/interference detection module 322 then looks for further interfering PSS signals, sending them to signal reconstruction module 324 and subtractor 326 for further interfering PSS signal removal, until signal/interference detection module 322 cannot find any further interfering PSS signals and outputs the NID2 value and the time and frequency location of the desired PSS signal at 327.

Received signal 321 is then input to SSS loop 330, along with output 327 of PSS loop 320 which, as noted above, includes the PSS position which can be used to find the SSS position. Signal/interference detection module 332, to which the output 327 of PSS loop 320 is input, identifies interfering SSSs. In each pass through loop 330, one interfering SSS identity is passed at 333 to signal reconstruction module 334 which isolates and reconstructs the identified interfering SSS 335 so that it can be subtracted at 336 from received signal 321. Signal/interference detection module 332 then looks for further interfering SSS signals, sending them to signal reconstruction module 334 and subtractor 336 for further interfering SSS signal removal, until signal/interference detection module 332 cannot find any further interfering SSS signals and outputs the NID1 value of the desired SSS signal at 337.

In accordance with implementations of the current disclosure, PSS detection is performed on the received signal to detect the time and frequency locations of the PSS, without performing SIC to determine NID2. This is possible because both the desired and interfering PSSs may be at the same time and frequency locations—indeed, if they were not, they would not interfere, so the locations can be determined without determining which is the interfering signal and which is the desired signal. The PSS locations are then passed with the received signal to the SSS detection module. Because NID2 is not determined during PSS detection, SSS detection determines NID2 as well as NID1. This means that SSS detection in accordance with these implementations of this disclosure exhaustively searches all possible PSS/SSS sets, or at least a well-designed subset. Although this results in a search of up to three times as many SSS possibilities (assuming all PSS possibilities are included), this is acceptable because the reduction in resources (i.e., the device area that would have been consumed by the PSS SIC loop) and PSS acquisition time resulting from skipping the PSS SIC step (which can have as many as eight iterations based on the number of possible interfering signals) more than makes up for the increased SSS acquisition time.

According to further implementations of this disclosure, PSS detection can be skipped altogether (and PSS detection circuitry can be eliminated altogether, saving further device area) if PSS locations are known, in which case the PSS locations are passed directly to the SSS detection module.

In any implementation of this disclosure, the SSS detection will examine three times as many possibilities—168 vs. 3×168). However, while multiple iterations of the PSS detection could require more than one frame duration, the SSS search is a pipelined operation that consumes only a fraction—about one-tenth—of a frame duration. Therefore, even multiplying that duration by 3 does not exceed one frame duration, so performance is not affected.

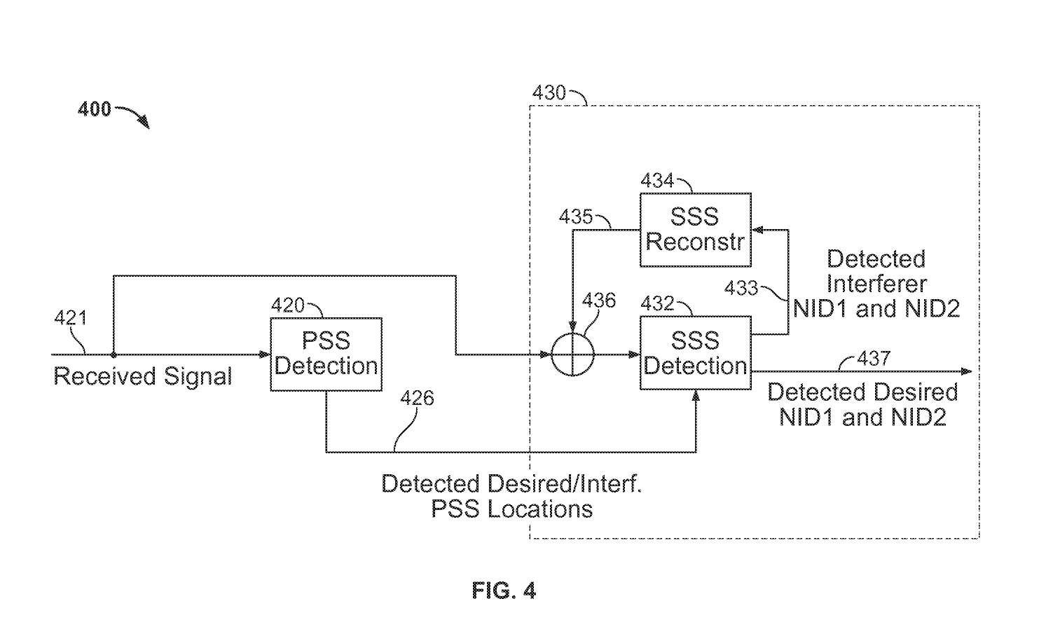

An implementation according to this disclosure is shown in FIG. 4. SIC method/circuit 400 includes a PSS detection module 420 and an SSS loop 430. Note that there is no PSS loop in SIC method/circuit 400, reducing device area as compared to a device incorporating a PSS SIC loop.

Received signal 421 is input to PSS detection module 420, where the time and frequency locations of the strongest signal—whether it is the desired signal or an interfering signal—is determined, and passed at 426 to SSS loop 430 which also receives received signal 421. As noted above, if the desired and interfering PSSs did not overlap in time and frequency, they would not be interfering. Therefore, using the time and frequency locations of the strongest signal is acceptable. The method and apparatus operate more quickly than known methods and apparatus by virtue of not having to select from among the competing PSSs.

Received signal 421 and the PSS time and frequency locations at 426 are then input to SSS signal/interference detection module 432, identifying interfering SSSs. In each pass through loop 430, one interfering SSS identity is passed at 433 to signal reconstruction module 434 which isolates and reconstructs the identified interfering SSS 435 (searching the 3×168 possibilities of NID2/NID1 pairs) so that it can be subtracted at 436 from received signal 421. Signal/interference detection module 432 then looks for further interfering SSS signals, sending them to signal reconstruction module 434 and subtractor 436 for further interfering SSS signal removal, until signal/interference detection module 432 cannot find any further interfering SSS signals and outputs the NID2 and NID1 values of the desired SSS signal at 437.

As noted above, if PSS time and frequency locations 426 can be known or determined in some other way and provided directly to SSS signal/interference detection module 432, then PSS detection module 420 can be omitted, saving processing time and further reducing device area.

FIG. 5 shows an example of a communications system 500 incorporating implementations of this disclosure. Communications system 500 may be a mobile communications system including a plurality of eNBs or base stations 501-508, as well as a plurality of mobile handsets (or similar mobile devices) 510, 520, 530, 540, 550. Each mobile device 510, 520, 530, 540, 550 includes circuitry 400.

At any one time, each mobile device may be in communication with one particular base station 501-508, but in range of more than one base station 501-508. In some cases, implementations of the present disclosure can be used to identify the signal from the correct one of base stations 501-508. In other cases, implementations of the present disclosure can be used to identify the desired signal from among competing signals 511, 512, 513 from the same base station 501. For example, base station 501 may be shared by multiple carriers, or a single carrier may offer more than one service. Method and circuitry 400 can be used to allow mobile device 510 to identify the desired signal from among competing signals 511, 512, 513. It is contemplated that any one mobile device may need to distinguish its desired signal from up to eight additional interfering signals.

Thus it is seen that a synchronization signal detection system and method that operates more quickly, and consumes less device area, has been provided. Further aspects of the present invention also relate to one or more of the following clauses:

Clause 1. A method of detecting a secondary synchronization signal in a received signal having desired primary and secondary synchronization signals and interfering primary and secondary synchronization signals, the method comprising:
providing information regarding primary synchronization signal location; and
based on the information regarding primary synchronization signal location, performing successive interference cancellation to remove the interfering secondary synchronization signals for detecting the desired secondary synchronization signal, without performing successive interference cancellation on the primary synchronization signals.

Clause 2. The method of clause 1, wherein providing information regarding primary synchronization signal location comprises deriving, from the received signal, the information regarding primary synchronization signal location.

Clause 3. The method of clause 2, wherein deriving, from the received signal, the information regarding primary synchronization signal location comprises detecting any of the desired and interfering primary synchronization signals.

Clause 4. The method of clause 3, wherein detecting any of the desired and interfering primary synchronization signals comprises detecting whichever of the desired and interfering primary synchronization signals is strongest.

Clause 5. The method of clause 1, wherein:
the desired primary synchronization signal comprises a first variable;
the desired secondary synchronization signal comprises a second variable; and
detecting the desired secondary synchronization signal comprises detecting the first variable and the second variable.

Clause 6. The method of clause 5, wherein detecting the first variable and the second variable comprises searching a plurality of first variable/second variable pairings.

Clause 7. Apparatus for detecting a secondary synchronization signal in a received signal having (i) desired primary and secondary synchronization signals and (ii) interfering primary and secondary synchronization signals, the apparatus comprising:
a source of information regarding primary synchronization signal location; and
successive interference cancellation circuitry that uses the information regarding primary synchronization signal location to remove the interfering secondary synchronization signals for detecting the desired secondary synchronization signal, without performing successive interference cancellation on the primary synchronization signals.

Clause 8. The apparatus of clause 7, wherein the source of information regarding primary synchronization signal location comprises a primary synchronization signal detector that derives, from the received signal, the information regarding primary synchronization signal location.

Clause 9. The apparatus of clause 8, wherein the primary synchronization signal detector derives, from the received signal, the information regarding primary synchronization signal location by detecting any of the desired and interfering primary synchronization signals.

Clause 10. The apparatus of clause 9, wherein herein the primary synchronization signal detector detects whichever of the desired and interfering primary synchronization signals is strongest.

Clause 11. The apparatus of clause 7, wherein:
the desired primary synchronization signal comprises a first variable;
the desired secondary synchronization signal comprises a second variable; and
the successive interference cancellation circuitry detects the first variable and the second variable.

Clause 12. The apparatus of clause 11, wherein the successive interference cancellation circuitry detects the first variable and the second variable by searching a plurality of first variable/second variable pairings.

Clause 13. A communications system comprising:
a plurality of base stations, each respective one of the base stations transmitting primary and secondary synchronization signals; and
a plurality of transceivers, each of the transceivers, at any one time, being in communication with a respective one of the base stations and including receiver circuitry for detecting a respective secondary synchronization signal from the respective one of the base stations while receiving (i) desired primary and secondary synchronization signals from the respective one of the base stations and (ii) interfering primary and secondary synchronization signals from other ones of the base stations, the receiver circuitry comprising:
a source of information regarding primary synchronization signal location; and
successive interference cancellation circuitry that uses the information regarding primary synchronization signal location to remove the interfering secondary synchronization signals for detecting the desired secondary synchronization signal, without performing successive interference cancellation on the primary synchronization signals.

Clause 14. The communications system of clause 13, wherein the source of information regarding primary synchronization signal location comprises a primary synchronization signal detector that derives, from the received signals, the information regarding primary synchronization signal location.

Clause 15. The communications system of clause 14, wherein the primary synchronization signal detector derives, from the received signals, the information regarding primary synchronization signal location by detecting any of the desired and interfering primary synchronization signals.

Clause 16. The communications system of clause 15, wherein herein the primary synchronization signal detector detects whichever of the desired and interfering primary synchronization signals is strongest.

Clause 17. The communications system of clause 13, wherein:
the desired primary synchronization signal comprises a first variable;
the desired secondary synchronization signal comprises a second variable; and
the successive interference cancellation circuitry detects the first variable and the second variable.

Clause 18. The communications system of clause 17, wherein the successive interference cancellation circuitry detects the first variable and the second variable by searching a plurality of first variable/second variable pairings.

Clause 19. The communications system of clause 13, wherein the transceivers comprise mobile telephones.

It will be understood that the foregoing is only illustrative of the principles of the invention, and that the invention can be practiced by other than the described embodiments, which are presented for purposes of illustration and not of limitation, and the present invention is limited only by the claims which follow.

What is claimed is:

1. A method of detecting a secondary synchronization signal in a received signal having desired primary and secondary synchronization signals and interfering primary and secondary synchronization signals, the method comprising:
providing information regarding primary synchronization signal location; and
based on the information regarding primary synchronization signal location, performing successive interference cancellation to remove the interfering secondary synchronization signals for detecting the desired secondary synchronization signal, without performing successive interference cancellation on the primary synchronization signals.

2. The method of claim 1, wherein providing information regarding primary synchronization signal location comprises deriving, from the received signal, the information regarding primary synchronization signal location.

3. The method of claim 2, wherein deriving, from the received signal, the information regarding primary synchronization signal location comprises detecting any of the desired and interfering primary synchronization signals.

4. The method of claim 3, wherein detecting any of the desired and interfering primary synchronization signals comprises detecting whichever of the desired and interfering primary synchronization signals is strongest.

5. The method of claim 1, wherein:
the desired primary synchronization signal comprises a first variable;
the desired secondary synchronization signal comprises a second variable; and
detecting the desired secondary synchronization signal comprises detecting the first variable and the second variable.

6. The method of claim 5, wherein detecting the first variable and the second variable comprises searching a plurality of first variable/second variable pairings.

7. Apparatus for detecting a secondary synchronization signal in a received signal having (i) desired primary and secondary synchronization signals and (ii) interfering primary and secondary synchronization signals, the apparatus comprising:
a source of information regarding primary synchronization signal location; and
successive interference cancellation circuitry that uses the information regarding primary synchronization signal location to remove the interfering secondary synchronization signals for detecting the desired secondary synchronization signal, without performing successive interference cancellation on the primary synchronization signals.

8. The apparatus of claim 7, wherein the source of information regarding primary synchronization signal location comprises a primary synchronization signal detector that derives, from the received signal, the information regarding primary synchronization signal location.

9. The apparatus of claim 8, wherein the primary synchronization signal detector derives, from the received signal, the information regarding primary synchronization signal location by detecting any of the desired and interfering primary synchronization signals.

10. The apparatus of claim 9, wherein herein the primary synchronization signal detector detects whichever of the desired and interfering primary synchronization signals is strongest.

11. The apparatus of claim 7, wherein:
the desired primary synchronization signal comprises a first variable;
the desired secondary synchronization signal comprises a second variable; and
the successive interference cancellation circuitry detects the first variable and the second variable.

12. The apparatus of claim 11, wherein the successive interference cancellation circuitry detects the first variable and the second variable by searching a plurality of first variable/second variable pairings.

13. A communications system comprising:
a plurality of base stations, each respective one of the base stations transmitting primary and secondary synchronization signals; and
a plurality of transceivers, each of the transceivers, at any one time, being in communication with a respective one of the base stations and including receiver circuitry for detecting a respective secondary synchronization signal from the respective one of the base stations while receiving (i) desired primary and secondary synchronization signals from the respective one of the base stations and (ii) interfering primary and secondary synchronization signals from other ones of the base stations, the receiver circuitry comprising:
a source of information regarding primary synchronization signal location; and
successive interference cancellation circuitry that uses the information regarding primary synchronization signal location to remove the interfering secondary synchronization signals for detecting the desired secondary synchronization signal, without performing successive interference cancellation on the primary synchronization signals.

14. The communications system of claim 13, wherein the source of information regarding primary synchronization signal location comprises a primary synchronization signal detector that derives, from the received signals, the information regarding primary synchronization signal location.

15. The communications system of claim 14, wherein the primary synchronization signal detector derives, from the received signals, the information regarding primary synchronization signal location by detecting any of the desired and interfering primary synchronization signals.

16. The communications system of claim 15, wherein herein the primary synchronization signal detector detects whichever of the desired and interfering primary synchronization signals is strongest.

17. The communications system of claim 13, wherein:
the desired primary synchronization signal comprises a first variable;
the desired secondary synchronization signal comprises a second variable; and
the successive interference cancellation circuitry detects the first variable and the second variable.

18. The communications system of claim 17, wherein the successive interference cancellation circuitry detects the first variable and the second variable by searching a plurality of first variable/second variable pairings.

19. The communications system of claim 13, wherein the transceivers comprise mobile telephones.
